(19) United States
(12) Patent Application Publication
(10) Pub. No.: US 2024/0424879 A1
(43) Pub. Date: Dec. 26, 2024

(54) ELECTRIC DRIVE SYSTEM AND METHOD FOR MINIMIZING MECHANICAL LOSSES IN AN AUXILIARY ELECTRIC DRIVE SYSTEM THEREOF

(71) Applicant: VINFAST TRADING AND PRODUCTION JOINT STOCK COMPANY, Hai Phong City (VN)

(72) Inventors: Duy Hai LE, Hai Phong City (VN); Bao Quoc NGUYEN, Hai Phong City (VN); Nam Cuong TRAN, Hai Phong City (VN); Mohammad Naeem KHAN, Hai Phong City (VN)

(21) Appl. No.: 18/748,280

(22) Filed: Jun. 20, 2024

(30) Foreign Application Priority Data
Jun. 21, 2023 (VN) 1- 2023-04068

(51) Int. Cl. B60K 1/02; B60K 17/02; B60K 17/16; B60K 17/356

(52) U.S. Cl. CPC B60K 1/02; B60K 17/02; B60K 17/16; B60K 17/356

(57) ABSTRACT

An electric drive system (EDS) employs one-way clutch integrated in an auxiliary EDS's transmission. The one-way clutch is located on a middle shaft of the auxiliary EDS's transmission that disconnects a first gear pair and a rotor shaft of the auxiliary EDS from the transmission rotation. The operation of the one-way clutch does not require an actuator to control the shifting of the clutch but using the motor itself for clutch engagement/disengagement. A method for minimizing mechanical losses in an auxiliary electric drive system of the electric drive system is also provided.

### CROSS-REFERENCE TO RELATED APPLICATION

This application claims priority from Vietnamese Application No. 1-2023-04068 filed Jun. 21, 2023, which is incorporated herein by reference in its entirety.

### TECHNICAL FIELD

The present invention relates generally to electric vehicles. More particularly, the present invention relates to an electric drive system and a method for minimizing mechanical losses in an auxiliary electric drive system of the electric drive system.

### BACKGROUND

In an electric vehicle, an electric drive system (EDS), generally including electric motor, gear transmission, and control unit (i.e., inverter), is provided with power by the energy stored in batteries to drive the vehicle moving forward and backward. The electric vehicle system does not need a reverse gear as in conventional gasoline engine vehicles, the electric motor(s) can operate in both directions to drive the wheels through a transmission. Therefore, the reverse gear is not needed.

In most of the electric vehicle, the electric motor not only works as a motor using electric energy stored in the battery to drive the vehicle moving forward and backward, but also works as a generator to convert kinetic energy during vehicle braking progress into electricity to recharge the battery. This process increases the energy consumption efficiency of the system. Because of this characteristic of the electric motor operation, the EDS has a much simpler transmission than that of a conventional automotive transmission and it is connected directly to the wheel through a drive shaft without any clutch or disconnect unit. Conventionally, the electric motor and the gears always run while the electric vehicle is running.

Currently, many electric vehicles are four-wheel drive using two independent EDSes. As an example vehicle 100 in FIG. 1, one EDS 101 is used as a main EDS to drive the front wheels and another EDS 102 is used as an auxiliary EDS to drive the rear wheels. The advantage of the configuration is that the using power of the system is optimized based on the vehicle operating conditions by controlling the operation of the two EDSes. When the vehicle requires less power, only one EDS (e.g., EDS 101) is activated to propel, the other is free running or the power is disconnected from the powertrain. When the high power is needed, the second EDS (e.g., EDS 102) is activated to provide more power to drive the electric vehicle.

However, if the auxiliary EDS is always connected to the drive shaft, it will be physically running even though it is not activated when the vehicle running. It leads to mechanical losses of the auxiliary EDS because of drag loss and other losses. It will decrease the efficiency of the system or lower the range of the electric vehicle. Furthermore, while a rotor of the electric motor of the auxiliary EDS is passively running due because the auxiliary EDS is always connected to the drive shaft, an electric current is generated inside a coil of the stator. It will cause issue if the controller (inverter) is not designed well to absorb the electric current.

To solve the above mentioned issue, the auxiliary EDS should be disconnected from the wheels (powertrain) when it is not operated, thus the losses of the EDS due to free running can be saved.

In some known electric vehicle systems, a dog clutch and an electromagnetic clutch are used to disconnect the auxiliary EDS when it is not operated. In such applications, the clutch requires actuators to control the engagement of the clutch. For example, in the design of Hyundai's EDS, the dog clutch is located on the drive shaft of the front EDS. During the vehicle running, the actuator will be activated to connect or disconnect the transmission and the rotor of the electric motor to the front drive shafts. This allows the vehicle to run in two operation modes, two-wheel drive and all-wheel drive. This operation increases the efficiency of the system. On the other hand, the range of the vehicle is increased. The advantage of such known applications is that the clutch is located outside the drive unit. It means that the adding of clutch to the drive system is flexible and easy to add or remove. It is also more convenient for the maintenance and repair.

However, such known applications have a lot of disadvantages. First, the design is not compact since the clutch needs an actuator to control. Second, such known applications require a complex control algorithm due to the requirement of synchronized speed between two shafts. Third, the actuator for controlling the clutch leads to an additional weight to the whole system. Finally, the operation of the system requires active lubrication, thus requiring a pump for this purpose.

### SUMMARY

The invention has been made to solve the above-mentioned problems, and an object of the invention is to provide an electric drive system that employs one-way clutch integrated in the auxiliary EDS's transmission and a method for minimizing mechanical losses in an auxiliary electric drive system of the electric drive system.

Problems to be solved in embodiments of the invention are not limited thereto and include the following technical solutions and also objectives or effects understandable from the embodiments.

According to an embodiment of the invention, there is provided an electric drive system for a vehicle including a first pair of wheels and a second pair of wheels, the system comprising:
a main electric drive system configured to drive the first pair of wheels via a first train of torque transmitters; and
an auxiliary electric drive system configured to transmit drive power from an electric motor to the second pair of wheels via an interruptive second train of torque transmitters including:
a differential;
a layshaft disposed between the electric motor and the differential;
a first layshaft gear configured to rotate freely relative to the layshaft via a needle bearing, wherein the first layshaft gear is further configured to connect to a rotor of the electric motor to transfer a torque from the electric motor to the layshaft;
a second layshaft gear and a differential gear connected to each other to transfer the torque between the layshaft and the differential;
a flange is provided inside of the first layshaft gear so that a hollow space is formed between the first layshaft gear and the flange, wherein the flange is fixedly attached to the layshaft so that the flange in combination with the first layshaft gear is capable of transferring the torque from the electric motor to the layshaft; and
a one-way clutch (OWC) provided to fit the hollow space so that when angular speed of the first layshaft gear is lower than angular speed of the flange, the OWC disconnects the first layshaft gear from the flange and thereby the layshaft rotates freely relative to the first layshaft gear and so that when angular speed of the first layshaft gear is equal to or faster than angular speed of the flange, the OWC connects the first layshaft gear and the flange as a block and thereby the torque is transferred from the electric motor to the layshaft and then from the layshaft to the differential.

According to another embodiment of the invention, there is provided a method for minimizing mechanical losses in an auxiliary electric drive system of an electric drive system for a vehicle including a first pair of wheels and a second pair of wheels, wherein the electric drive system comprises:
a main electric drive system configured to drive the first pair of wheels via a first train of torque transmitters; and
the auxiliary electric drive system configured to transmit drive power from an electric motor to the second pair of wheels via an interruptive second train of torque transmitters including:
a differential;
a layshaft disposed between the electric motor and the differential;
a first layshaft gear configured to rotate freely relative to the layshaft via a needle bearing, and wherein the first layshaft gear is further configured to connect to a rotor of the electric motor to transfer a torque from the electric motor to the layshaft;
a second layshaft gear and a differential gear connected to each other to transfer the torque between the layshaft and the differential;
a flange is provided inside of the first layshaft gear so that a hollow space is formed between the first layshaft gear and the flange, wherein the flange is fixedly attached to the layshaft so that the flange in combination with the first layshaft gear is capable of transferring the torque from the electric motor to the layshaft; and
a one-way clutch (OWC) provided to fit the hollow space;
the method comprising:
turning the electric motor on when an additional propulsive energy is required above a primary propulsive energy level provided by the main electric drive system;
connecting the first layshaft gear and the flange as a block by engaging the OWC when the electric motor is on and angular speed of the first layshaft gear is equal to or faster than angular speed of the flange and thereby the torque is transferred from the electric motor to the layshaft and then from the layshaft to the differential;
disconnecting the first layshaft gear from the flange by disengaging the OWC when the electric motor is off and angular speed of the first layshaft gear is lower than angular speed of the flange and thereby the layshaft rotates freely relative to the first layshaft gear to prevent rotation of the first layshaft gear and of the rotor of the electric motor.

According to embodiments of the invention, the operation of the one-way clutch does not require an actuator to control the shifting of the clutch but using the electronic motor itself to engage or disengage the clutch. Therefore, the EDS structure is very compact and the control is simple. The simulation results show that if the auxiliary EDS is disconnected from the powertrain in some circumstances, the range of the vehicle can be increased about 10 kilometers.

### BRIEF DESCRIPTION OF THE DRAWINGS

The accompanying drawings illustrate preferred embodiments of the present invention, and together with the following detailed description of the present invention, serve to provide a further understanding of the technical aspects of the present invention, and thus the present invention should not be construed as limited to the drawings.

FIG. 1 is a schematic diagram illustrating a configuration of a four-wheel drive electric vehicle.

FIG. 2 is a schematic diagram of an example electric vehicle using a disconnect unit.

FIG. 3 is a schematic diagram explaining one-way clutch (OWC) structure and operation.

FIG. 4 shows a schematic diagram of an auxiliary EDS with the OWC integrated into a layshaft.

FIG. 5A is a schematic diagram showing operation of the auxiliary EDS in a disengaged status of the OWC.

FIG. 5B is a schematic diagram showing operation of the auxiliary EDS in an engaged status of the OWC.

FIG. 6A shows a schematic diagram of the disconnect unit of the auxiliary EDS as described in FIG. 4 according to a first embodiment.

FIG. 6B show a section view of the disconnect unit of FIG. 6A at the OWC position.

FIG. 6C and FIG. 6D show exploded views of the layshaft integrated the disconnect unit of FIG. 6A.

FIG. 7A shows a schematic diagram of the disconnect unit as described in FIG. 4 according to a second embodiment.

FIG. 7B shows an exploded view of the disconnect unit of FIG. 7A.

FIG. 8 is a flow diagram of an example process for minimizing mechanical losses in an auxiliary EDS.

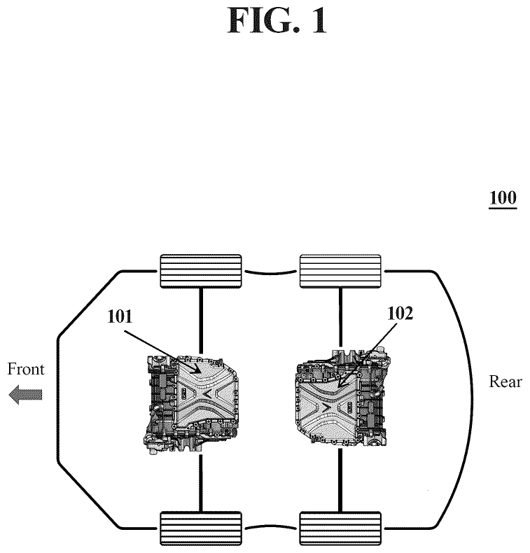

### DETAILED DESCRIPTION

Hereinafter, the preferred embodiments of the present invention will be described in detail with reference to the accompanying drawings. The embodiments described herein and illustrations shown in the drawings are just a most preferred embodiment of the present invention, but not intended to fully describe the technical aspects of the present invention, so it should be understood that a variety of other equivalents and variations could be made thereto at the time of filing the application.

Additionally, in describing the present invention, when it is deemed that a detailed description of relevant known elements or functions renders the key subject matter of the present invention ambiguous, the detailed description is omitted herein.

It should be understood that, although the terms “first,” “second,” “primary,” “secondary,” and the like may be used herein to describe various elements, the elements are not limited by the terms. The terms are only used to distinguish one element from another element. For example, a first element could be termed a second element, and, similarly, a second element could be termed a first element without departing from the scope of the invention. As used herein, the term “and/or” includes any and all combinations of one or more of the associated listed items.

The terminology used herein is for the purpose of describing particular embodiments only and is not intended to be limiting to the invention. As used herein, the singular forms “a,” “an,” “another,” and “the” are intended to also include the plural forms, unless the context clearly indicates otherwise. It should be further understood that the terms “comprise,” “comprising,” “include,” and/or “including,” when used herein, specify the presence of stated features, integers, steps, operations, elements, parts, or combinations thereof, but do not preclude the presence or addition of one or more other features, integers, steps, operations, elements, parts, or combinations thereof.

In addition, throughout the specification, it will be further understood that when an element is referred to as being “connected to” another element, it can be directly connected to the other element or intervening elements may be present.

Unless otherwise defined, all terms including technical and scientific terms used herein have the same meaning as commonly understood by one of ordinary skill in the art to which this invention belongs. It should be further understood that terms, such as those defined in commonly used dictionaries, should be interpreted as having a meaning that is consistent with their meaning in the context of the relevant art and are not to be interpreted in an idealized or overly formal sense unless expressly so defined herein.

Hereinafter, embodiments will be described in detail with reference to the accompanying drawings, the same or corresponding components are denoted by the same reference numerals, and thus the description thereof will not be repeated.

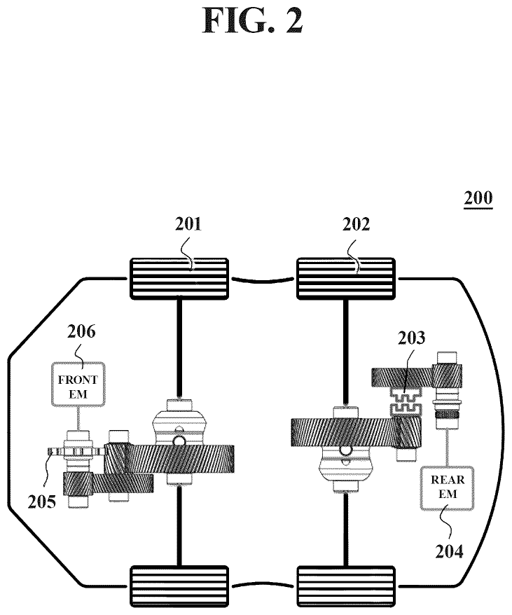

FIG. 2 is a schematic diagram of an example electric vehicle 200 using a disconnect unit (DCU) 203. The electric vehicle 200 uses two electric drive systems (EDS) including a main EDS configured to drive a first pair of wheels and an auxiliary EDS configured to transmit drive power from an electric motor to a second pair of wheels. As illustrated in FIG. 2, the main EDS is a front EDS driving the front wheels 201 while the auxiliary EDS is a rear EDS driving the rear wheels 202. However, according to another embodiment, the main EDS may be provided as a rear EDS, and the auxiliary EDS may be provided as a front EDS. A park lock mechanism 205 of the electric vehicle 200 is located inside the front EDS with the front electric motor 206. The DCU 203 is located inside the rear EDS with the rear electric motor 204. During the operation of the electric vehicle 200, the DCU 203 engages or disengages the rear electric motor 204 from the vehicle power train. Thus, it reduces the drag loss of the rear electric motor 204 and increases the vehicle efficiency (i.e., increase the vehicle range).

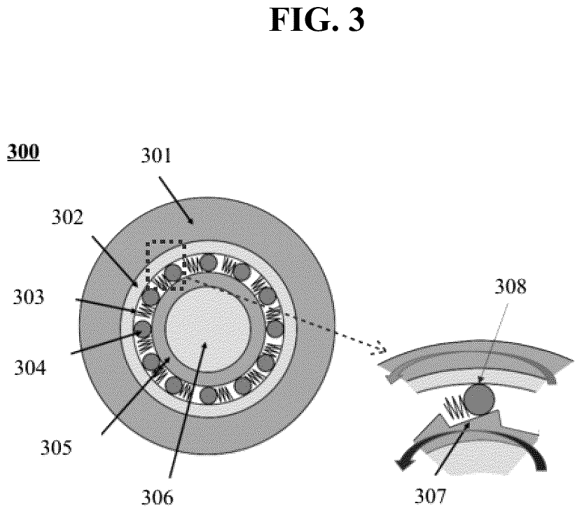

According to an embodiment, a one-way-clutch (OWC) is used as a DCU integrated into the auxiliary EDS. FIG. 3 shows a section view of an example OWC 300 and its operation. The OWC 300 includes an inner ring 305, an outer ring 302, rollers 304 and springs 303. The inner ring 305 is designed with many ramp shapes 307, and the rollers 304 and the springs 303 that are assembled in the spaces between the outer ring 302 and the inner ring 305. The springs 303 act as a preloaded pusher to push the rollers 304 to contact both surfaces of the inner ring 305 and the outer ring 302. Assumed that two mechanisms, which will be engaged and disengaged, are mounted to the inner ring 305 and the outer ring 302. In particular, a shaft 306 is mounted to the inner ring 305 and a housing 301 is mounted to the outer ring 302. The operation or status of the OWC depends on the speed difference between the inner ring 305 and the outer ring 302.

When angular speed of the inner ring 305 is equal or faster than that of the outer ring 302 (in a counter clockwise direction—CCW), the rollers 304 engages the inner ring 305 and the outer ring 302 as a rigid body automatically. Therefore, the shaft 306 and the housing 301 are blocked together.

When the angular speed of the inner ring 305 is slower than that of the outer ring 302 (in CCW direction), the rollers 304 will be released to disengage the inner ring 305 and the outer ring 302, thus the shaft 306 and the housing 301 is disengaged.

In an opposite direction (i.e., clockwise direction), the function is reversed. It means the OWC will be engaged when angular speed of the outer ring 302 is faster than that of the inner ring 305 and vice versa.

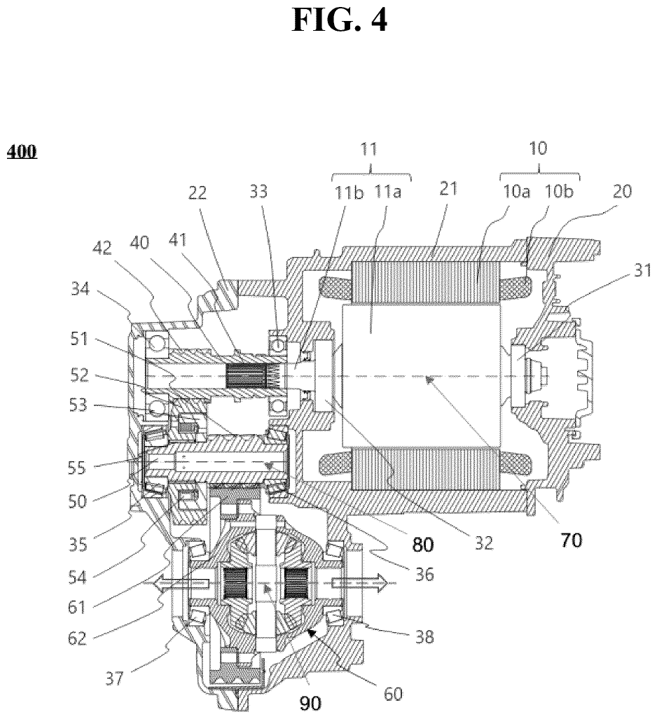

An embodiment of the invention employs the OWC theory as described above in FIG. 3 to design the disconnect unit integrated into the auxiliary EDS of the electric vehicle as described in FIG. 2. FIG. 4 shows a schematic diagram of the auxiliary EDS 400 with the OWC 54 integrated into a layshaft (i.e., a middle shaft) of the two level gear reduction ratio.

The electric motor of the auxiliary EDS 400 includes a stator 10, which contains a stator stack 10a and a winding 10b. The stator 10 is pressed fit into a main housing 21. A rotor 11 of the auxiliary EDS 400 includes a rotor core 11a and a rotor shaft 11b. The rotor 11 can rotate around a first axis 70 under the electromagnetic force from the stator 10. The rotor 11 is supported by two bearings, a rear rotor bearing 31 and a front rotor bearing 32. The front rotor bearing 32 is located on a bearing bore on the main housing 21 and the rear rotor bearing 31 is seat on a bearing bore on a rear housing 20.

An input shaft 40, designed as hollow type with internal spline, is connected to the rotor shaft 11b through a spline area 41 to transfer torque and speed from the electric motor. The input shaft 40 rotates around the same first axis 70 of the rotor shaft 11b and is supported by two bearings 33 and 34 in which the first input shaft bearing 33 is located on a bearing bore of the main housing 21 and the second input shaft bearing 34 is located on a bearing bore of a transmission housing 22. The torque and speed from the input shaft 40 is transferred to a layshaft 50 through a first gear pair 42 and 52. A first layshaft gear 52 can rotate freely relative to the layshaft 50 supported by a needle bearing 55. When the OWC 54 is activated, the first layshaft gear 52 and a flange 53 are engaged as one block. The flange 53 is provided inside of the first layshaft gear 52 so that a hollow space is formed between the first layshaft gear 52 and the flange 53. The flange 53 is fixedly mounted on the layshaft 50, thus the torque and speed from the input shaft 40 can be transferred to the layshaft 50 via a combination of the flange 53 and the first layshaft gear 52. The layshaft 50 is rotated around a second axis 80 and supported by two bearings, a first taper bearing 35 located on the transmission housing 22 and the second taper bearing 36 located on a bearing bore of the main housing 21.

The torque and speed of the layshaft 50 is transferred to a third axis 90 through a second gear pairs 51 and 61. In particular, a second layshaft gear 51 on the layshaft 50 and a differential gear 61 on a differential case 62 of a differential 60 connects to each other to transfer the torque between the layshaft 50 and the differential 60. The differential 60 rotates around the third axis 90 and supported by two differential bearings 37 and 38, which are located on the transmission housing 22 and the main housing 21, respectively. Then, drive shafts from the wheels are connected to the differential 60 for power transferring.

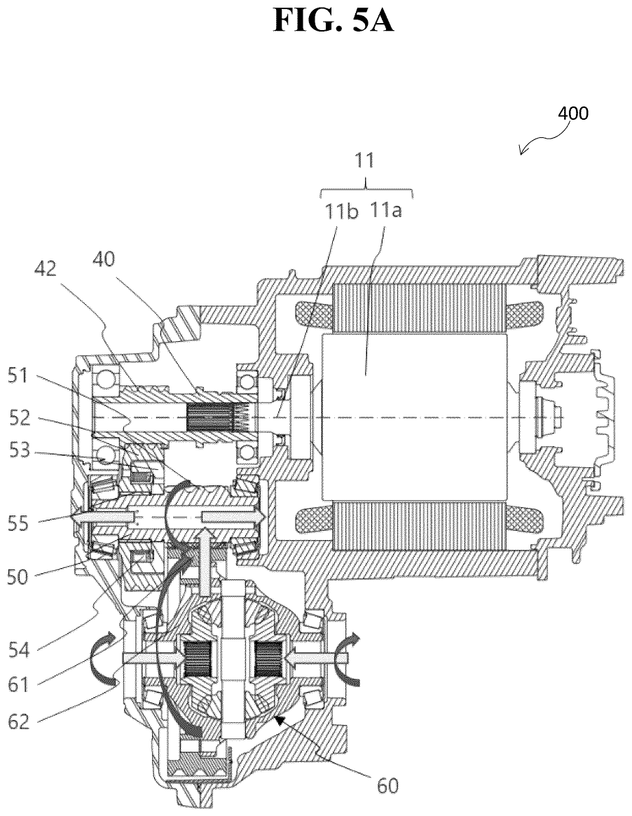

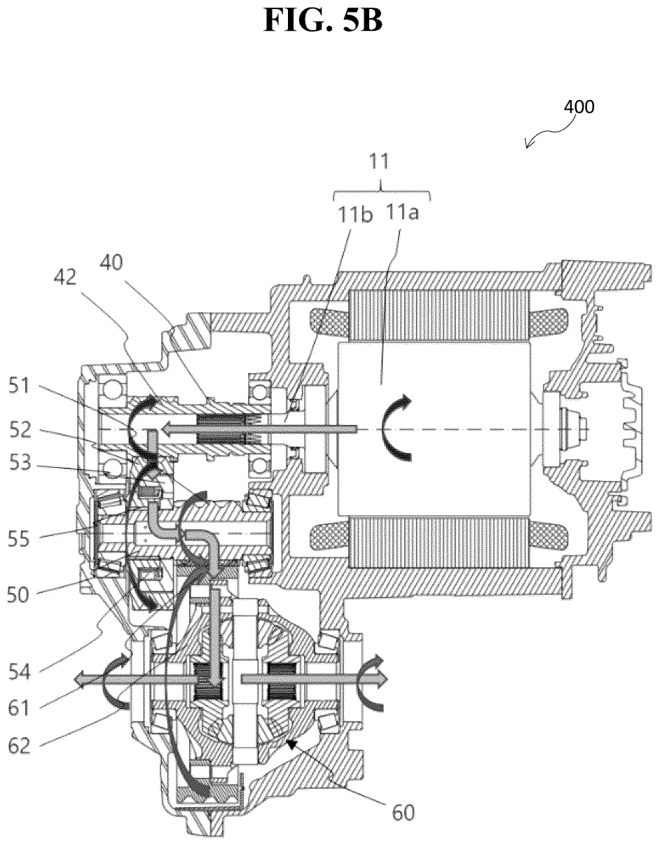

FIG. 5A is a schematic diagram showing operation of the auxiliary EDS 400 in a disengaged status of the OWC 54. In the disengaged status, the rotor 11, the input shaft 40, and the first layshaft gear 52 on the layshaft 50 are standstill or idle. When the vehicle is running, the differential 60 rotates and transfers the torque and speed to the layshaft 50 through the second gear pairs 51 and 61. That is, when angular speed of the first layshaft gear 52 is lower than angular speed of the flange 53 and layshaft 50, the OWC disengages the first layshaft gear 52 and the flange 53, thus the layshaft 50 is rotated freely relative to the layshaft 50.

FIG. 5B is a schematic diagram showing operation of the auxiliary EDS 400 in an engaged status of the OWC 54. When an additional propulsive energy is required above a primary propulsive energy level provided by the main electric drive system, the rotor 11 starts running in speed control mode then rotate the first layshaft gear 52 on the layshaft 50 through the input shaft 40 and the rotor gear 42. When angular speed of the first layshaft gear 52 equals to or faster than angular speed of the flange 53 and layshaft 50, the OWC 54 is automatically engaged and block the first layshaft gear 52 and flange 53, the torque and speed of the electric motor is transferred to the layshaft 50 and then from the layshaft 50 to the differential 60. The differential 60 is configured for transferring the torque and speed to the second pair of wheels.

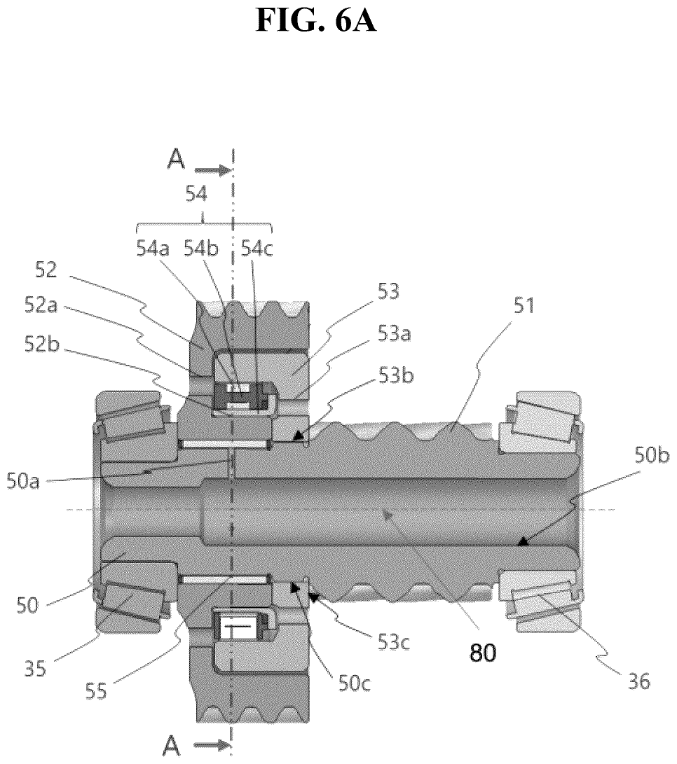

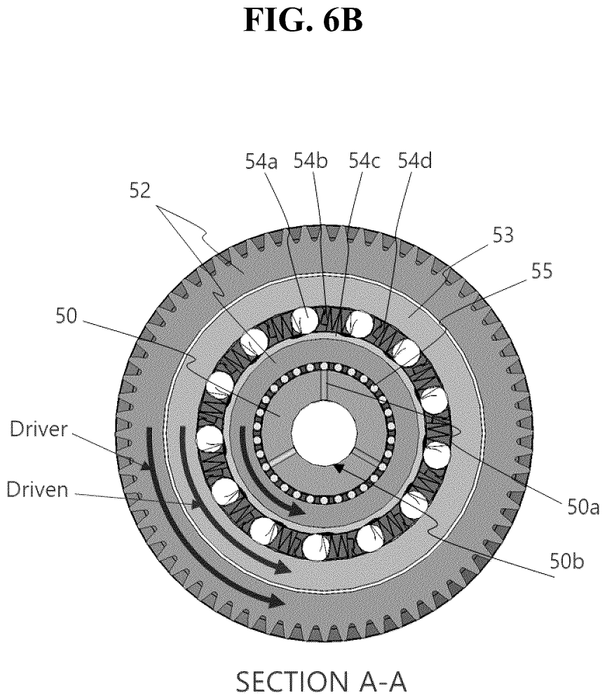

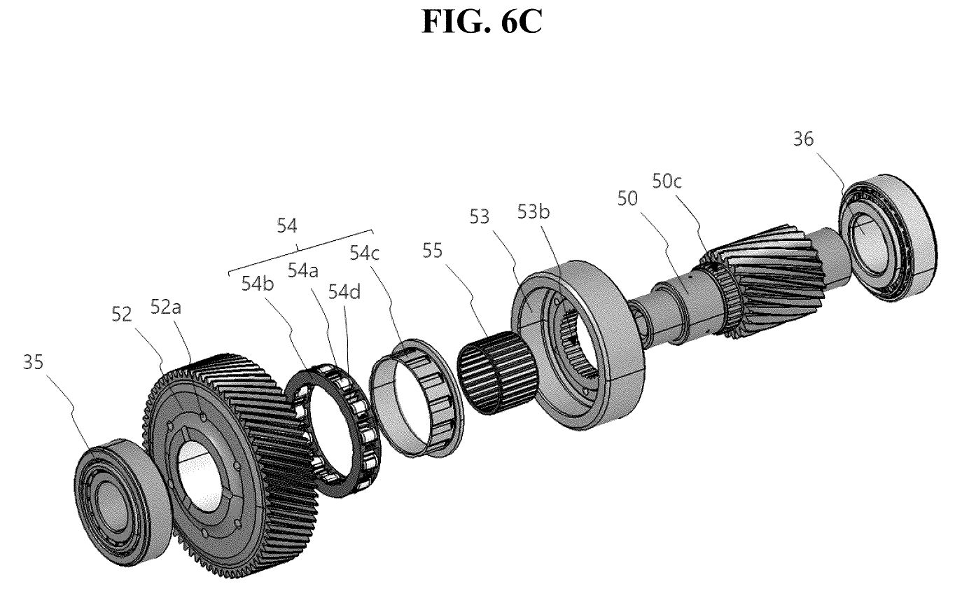

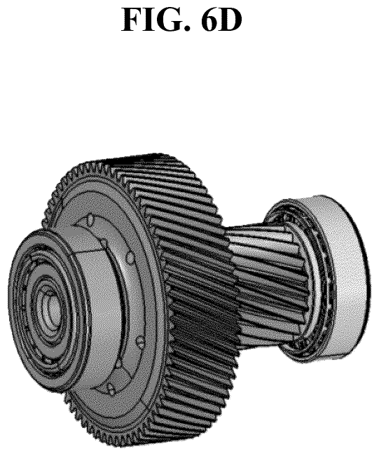

FIG. 6A shows a schematic diagram of the disconnect unit of the auxiliary EDS as described in FIG. 4 according to a first embodiment of the invention. FIG. 6B show a section view of the disconnect unit of FIG. 6A at the OWC 54 position. FIG. 6C and FIG. 6D show exploded views of the layshaft integrated the disconnect unit of FIG. 6A. The following description is made with reference to FIG. 6A, FIG. 6B, FIG. 6C and FIG. 6D in which the same or corresponding components are denoted by the same reference numerals, and thus the description thereof will not be repeated.

To save the space, the flange 53 is provided inside of the first layshaft gear 52 so that a hollow space is formed between the first layshaft gear 52 and the flange 53. The OWC 54 is provided to fit the hollow space. The OWC 54 includes rollers 54a, a roller case 54b, a ramp ring 54c, and springs 54d. These parts are assembled together as OWC assembly according to the OWC theory as described in FIG. 3. The ramp ring 54c of the OWC 54 is pressed fit into the hollow space on an inner surface 52b of the first layshaft gear 52.

The flange 53 is fixedly attached to the layshaft 50 by fixedly engaging a spline area 53b of the flange 53 with a coordinating area 50c of the layshaft 50. The flange 53 is contacted with the second layshaft gear 51 at a flange surface 53c. Therefore, the flange 53 in combination with the first layshaft gear 52 is capable of transferring the torque from the electric motor to the layshaft 50. On the other hand, the first layshaft gear 52 can rotate freely relative to the layshaft 50 via a needle bearing 55. The needle bearing 55 is a long type bearing that increases the stability of the first layshaft gear 52 and decreases NVH (noise, vibration, and harshness) level of the first layshaft gear 52 during operation.

According to the first embodiment, the layshaft 50 is supported by two taper bearings 35 and 36. The needle bearing 55 is in contact with the layshaft 50. The two taper bearings 35 and 36 are respectively in contact with the two ends of the layshaft. The disconnect unit of the auxiliary EDS 400 are assembled as a sub-module during assembly process in which disconnected unit parts comprising the OWC 54, the first layshaft gear 52, the flange 53 and the layshaft 50 are coaxial.

To solve the lubrication issue, the layshaft 50 is designed as a hollow shaft to let the lubrication oil come into an oil passage 50b. When the layshaft 50 rotates, the oil will be spayed out and lead to the needle bearing 55 for lubrication by layshaft oil holes 50a on the layshaft 50. The oil then goes out from the needle bearing 55 through the gaps between the disconnected unit parts. For lubricating the OWC 54, gear oil holes 52a are provided on the first layshaft gear and flange oil holes 53a are provided on the flange 53 to let the oil goes in and out of the OWC 54.

FIG. 6B shows the section view of the disconnect unit (DCU) at the OWC 54 position. It shows a driver component and a driven component of the DCU based on the OWC theory as described in FIG. 3. As described in the OWC theory illustrated in FIG. 3, the OWC 54 is controlled by the input speed of the first layshaft gear 52 in CCW direction. When angular speed of the first layshaft gear 52 is equal to or faster than that of the flange 53, the rollers 54a of the OWC 54 engages the flange 53 and the first layshaft gear 52 as a rigid body automatically. Therefore, the layshaft 50 and the first layshaft gear 52 are blocked together and thereby the torque is transferred from the electric motor to the layshaft 50 and then from the layshaft 50 to the differential 60.

When the angular speed of the first layshaft gear 52 is lower than that of the flange 53, the rollers 54a of the OWC 54 will be released to disengage the flange 53 and the first layshaft gear 52, thus the layshaft 50 and the first layshaft gear 52 is disengaged so that the layshaft 50 rotates freely relative to the first layshaft gear 52 to prevent rotation of the first layshaft gear 52 and of the rotor 11 of the electric motor.

In an opposite direction (i.e., clockwise direction), the function is reversed. It means the OWC will be engaged when angular speed of the first layshaft gear 52 is lower than that of the flange 53 and vice versa.

FIG. 6C shows an exploded view of the disconnect unit of the auxiliary EDS of FIG. 6A for clearly describe the detailed design of the releasable disconnected unit parts. FIG. 6D shows an exploded view of the disconnect unit of FIG. 6A in which the releasable disconnected unit parts are assembled into a functional layshaft assembly. The same or corresponding components in FIG. 6C and FIG. 6D are denoted by the same reference numerals of FIG. 6A, and FIG. 6B, and thus the description thereof will be omitted for brevity.

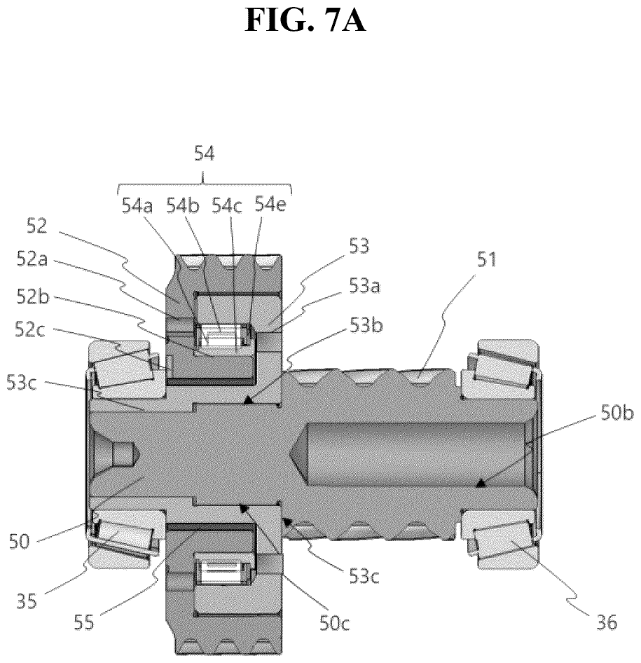

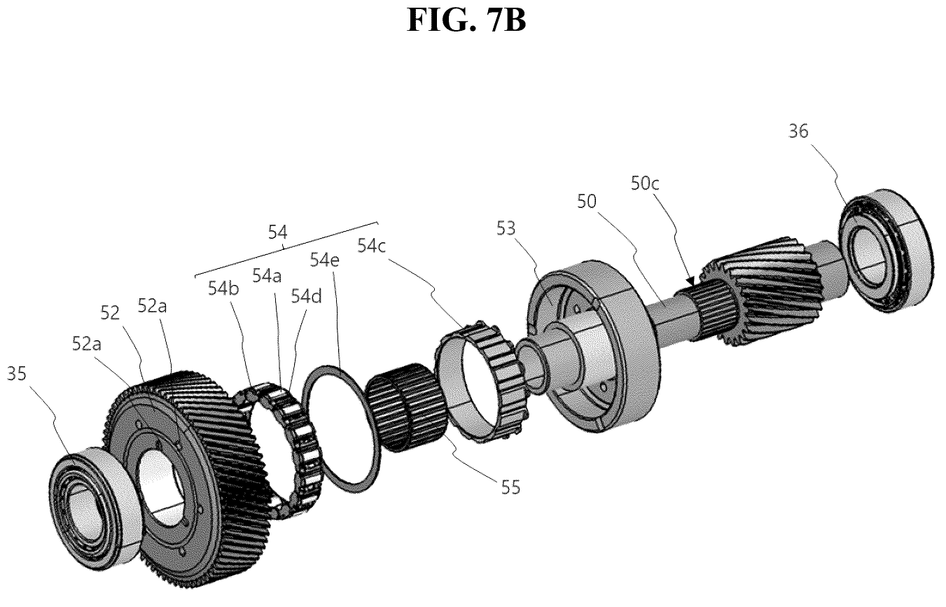

FIG. 7A shows a schematic diagram of the disconnect unit of the auxiliary EDS as described in FIG. 4 according to a second embodiment of the invention. FIG. 7B shows an exploded view of the disconnect unit of FIG. 7A. The following description is made with reference to FIG. 7A, and FIG. 7B in which the same or corresponding components are denoted by the same reference numerals, and thus the description thereof will not be repeated. The second embodiment is different from the first embodiment in terms of the flange design and the lubrication concept of the needle bearing.

Similar to the first embodiment, the flange 53 is provided inside of the first layshaft gear 52 so that a hollow space is formed between the first layshaft gear 52 and the flange 53. The OWC 54 is provided to fit the hollow space. However, unlike the first embodiment, the OWC 54 includes five components which are rollers 54a, a roller case 54b, a ramp ring 54c, springs 54d and a washer 54c. These parts are assembled together as OWC assembly. The ramp ring 54c of the OWC 54 is pressed fit into the hollow space on an inner surface 52b of the first layshaft gear 52.

Also similar to the first embodiment, the flange 53 is fixedly attached to the layshaft 50 by fixedly engaging a spline area 53b of the flange 53 with a coordinating area 50c of the layshaft 50. The flange 53 is contacted with the second layshaft gear 51 at a flange surface 53c. Therefore, the flange 53 in combination with the first layshaft gear 52 is capable of transferring the torque from the electric motor to the layshaft 50. On the other hand, the first layshaft gear 52 can rotate freely relative to the layshaft 50 via a needle bearing 55. The needle bearing 55 is a long type bearing that increases the stability of the first layshaft gear 52 and decreases NVH (noise, vibration, and harshness) level of the first layshaft gear 52 during operation.

According to the second embodiment, the layshaft 50 is supported by two taper bearings 35 and 36. However, in this embodiment, the flange 53 is extended to one end of the layshaft so that the needle bearing 55 is in contact with the flange 53. One of the two taper bearings (i.e., the first taper bearing 35 in FIG. 7A) is in contact with the flange 53, and the other taper bearing (i.e., the second taper bearing 36 in FIG. 7A) is in contact with the other end of the layshaft 50. The disconnect unit of the auxiliary EDS 400 are assembled as a sub-module during assembly process in which disconnected unit parts comprising the OWC 54, the first layshaft gear 52, the flange 53 and the layshaft 50 are coaxial.

The operation of the OWC 54 in the second embodiment is the same as that of the first embodiment which is described in FIG. 6B, thus the description thereof will be omitted for brevity.

In respect of lubrication issue of the second embodiment, the first layshaft gear 52 is provided with gear oil paths 52c to input the oil into the needle bearing 55 for lubrication and the oil goes out from the needle bearing 55 through gaps between the disconnected unit parts. Further, similar to the first embodiment, the first layshaft gear 52 is also provided with gear oil holes 52a to input the oil into the OWC 54 for lubrication and the flange 53 is provided with flange oil holes 53a to output the oil from the OWC 54.

FIG. 7B shows the exploded view of the layshaft integrated the disconnect unit of FIG. 7A for clearly describe the detailed design of the releasable disconnected unit parts. The same or corresponding components in FIG. 7B are denoted by the same reference numerals of FIG. 7A, and thus the description thereof will be omitted for brevity.

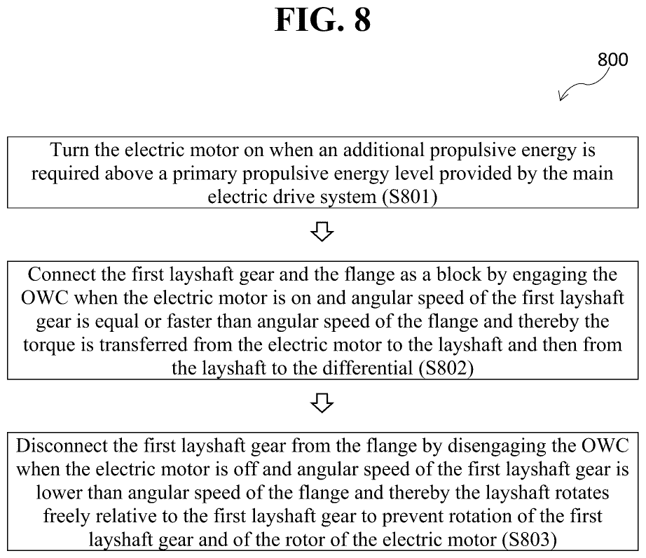

FIG. 8 is a flow diagram of an example process 800 for minimizing mechanical losses in an auxiliary electric drive system (for example, the auxiliary electric drive system 400 of FIG. 4) of an electric drive system for a vehicle including a first pair of wheels and a second pair of wheels (for example, the vehicle 200 of FIG. 2).

In particular, the electric drive system comprises a main electric drive system configured to drive the first pair of wheels via a first train of torque transmitters; and the auxiliary electric drive system configured to transmit drive power from an electric motor to the second pair of wheels via an interruptive second train of torque transmitters.

The interruptive second train of torque transmitters includes:
i) a differential (for example, the differential 60 of FIG. 4);
ii) a layshaft (for example, the layshaft 50 of FIG. 4) disposed between the electric motor and the differential;
iii) a first layshaft gear (for example, the first layshaft gear 52 of FIG. 4) configured to rotate freely relative to the layshaft via a needle bearing (for example, the needle bearing 55 of FIG. 4), and wherein the first layshaft gear is further configured to connect to a rotor of the electric motor to transfer a torque from the electric motor to the layshaft;
iv) a second layshaft gear (for example, the second layshaft gear 51 of FIG. 4) and a differential gear (for example, the differential gear 61 of FIG. 4) connected to each other to transfer the torque between the layshaft and the differential;
v) a flange (for example, the flange 53 of FIG. 4) is provided inside of the first layshaft gear so that a hollow space is formed between the first layshaft gear and the flange; wherein the flange is fixedly attached to the layshaft so that the flange in combination with the first layshaft gear is capable of transferring the torque from the electric motor to the layshaft; and
vi) a one-way clutch (OWC) (for example, the OWC 54 of FIG. 4) provided to fit the hollow space.

The process 800 comprises the following steps.

Step S801: Turning the electric motor on when an additional propulsive energy is required above a primary propulsive energy level provided by the main electric drive system.

Step S802: Connecting the first layshaft gear and the flange as a block by engaging the OWC when the electric motor is on and angular speed of the first layshaft gear is equal or faster than angular speed of the flange and thereby the torque is transferred from the electric motor to the layshaft and then from the layshaft to the differential.

Step S803: Disconnecting the first layshaft gear from the flange by disengaging the OWC when the electric motor is off and angular speed of the first layshaft gear is lower than angular speed of the flange and thereby the layshaft rotates freely relative to the first layshaft gear to prevent rotation of the first layshaft gear and of the rotor of the electric motor.

According to some embodiments, disconnected unit parts comprising the OWC, the first layshaft gear, the flange and the layshaft are coaxial.

According to the first embodiment, the layshaft is configured as a hollow shaft forming an oil passage to input oil. The layshaft is also provided with layshaft oil holes (for example, the layshaft oil holes 50a of FIG. 6A) so that when the layshaft rotates, the oil from the oil passage is spayed out and lead to the needle bearing for lubrication through the layshaft oil holes and the oil goes out from the needle bearing through gaps between the disconnected unit parts. Further, the first layshaft gear is provided with gear oil holes (for example, the gear oil holes 52a of FIG. 6A) to input the oil into the OWC for lubrication and the flange is provided with flange oil holes (for example, the flange oil holes 53a of FIG. 6A) to output the oil from the OWC.

According to the first embodiment, the layshaft is supported by two taper bearings. The needle bearing is in contact with the layshaft. The two taper bearings are in contact with the two ends of the layshaft.

According to the first embodiment, the OWC comprises rollers (for example, the rollers 54a of FIG. 6B), a roller case (for example, the roller case 54b of FIG. 6B), a ramp ring (for example, the ramp ring 54c of FIG. 6B) and springs (for example, the springs 54d of FIG. 6B), wherein the ramp ring is provided fit into the hollow space on an inner surface of the first layshaft gear.

According to a second embodiment, the layshaft is supported by two taper bearings. The flange is extended to one end of the layshaft so that the needle bearing is in contact with the flange, one of the two taper bearings is in contact with the flange, and the other taper bearing is in contact with the other end of the layshaft.

According to the second embodiment, the first layshaft gear is provided with gear oil paths (for example, the gear oil paths 52c of FIG. 7A) to input the oil into the needle bearing for lubrication and the oil goes out from the needle bearing through gaps between the disconnected unit parts; and the first layshaft gear is provided with gear oil holes (for example, the gear oil holes 52a of FIG. 7A) to input the oil into the OWC for lubrication and the flange is provided with flange oil holes (for example, the flange oil holes 53a of FIG. 7A) to output the oil from the OWC.

According to the second embodiment, the OWC comprises rollers (for example, the rollers 54a of FIG. 7B), a roller case (for example, the roller case 54b of FIG. 7B), a ramp ring (for example, the ramp ring 54c of FIG. 7B), springs (for example, the springs 54d of FIG. 7B) and a washer (for example, the washer 54e of FIG. 7B), wherein the ramp ring is provided fit into the hollow space on an inner surface of the first layshaft gear.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results.

What is claimed is:

1. An electric drive system for a vehicle including a first pair of wheels and a second pair of wheels, the system comprising:
a main electric drive system configured to drive the first pair of wheels via a first train of torque transmitters; and
an auxiliary electric drive system configured to transmit drive power from an electric motor to the second pair of wheels via an interruptive second train of torque transmitters including,
wherein the interruptive second train of torque transmitters includes:
a differential;
a layshaft disposed between the electric motor and the differential;
a first layshaft gear configured to rotate freely relative to the layshaft via a needle bearing, wherein the first layshaft gear is further configured to connect to a rotor of the electric motor to transfer a torque from the electric motor to the layshaft;
a second layshaft gear and a differential gear connected to each other to transfer the torque between the layshaft and the differential;
a flange provided inside of the first layshaft gear so that a hollow space is formed between the first layshaft gear and the flange, wherein the flange is fixedly attached to the layshaft so that the flange in combination with the first layshaft gear is capable of transferring the torque from the electric motor to the layshaft; and
a one-way clutch (OWC) provided to fit the hollow space so that when an angular speed of the first layshaft gear is lower than an angular speed of the flange, the OWC disconnects the first layshaft gear from the flange, thereby allowing the layshaft to rotate freely relative to the first layshaft gear, and when the angular speed of the first layshaft gear is equal to or faster than the angular speed of the flange, the OWC connects the first layshaft gear and the flange as a block, thereby allowing the torque to be transferred from the electric motor to the layshaft and then from the layshaft to the differential.

2. The electric drive system of claim 1, wherein disconnected unit parts comprising the OWC, the first layshaft gear, the flange, and the layshaft are coaxial.

3. The electric drive system of claim 2, wherein the layshaft is configured as a hollow shaft forming an oil passage to input oil,
wherein the layshaft is provided with layshaft oil holes so that when the layshaft rotates, the oil from the oil passage is spayed out and lead to the needle bearing for lubrication through the layshaft oil holes and the oil goes out from the needle bearing through gaps between the disconnected unit parts, and
wherein the first layshaft gear is provided with gear oil holes to input the oil into the OWC for lubrication and the flange is provided with flange oil holes to output the oil from the OWC.

4. The electric drive system of claim 2, wherein the layshaft is supported by two taper bearings,
wherein the needle bearing is in contact with the layshaft, and
wherein the two taper bearings are in contact with two ends of the layshaft.

5. The electric drive system of claim 2, wherein the layshaft is supported by two taper bearings, and
wherein the flange is extended to one end of the layshaft so that
the needle bearing is in contact with the flange;
one of the two taper bearings is in contact with the flange, and
the other of the two taper bearings is in contact with the other end of the layshaft.

6. The electric drive system of claim 5, wherein the first layshaft gear is provided with gear oil paths to input the oil into the needle bearing for lubrication and the oil goes out from the needle bearing through gaps between the disconnected unit parts, and
wherein the first layshaft gear is provided with gear oil holes to input the oil into the OWC for lubrication and the flange is provided with flange oil holes to output the oil from the OWC.

7. The electric drive system of claim 2, wherein the OWC comprises rollers, a roller case, a ramp ring, and springs, wherein the ramp ring is provided to fit into the hollow space on an inner surface of the first layshaft gear.

8. The electric drive system of claim 6, wherein the OWC further comprises a washer.

9. A method for minimizing mechanical losses in an auxiliary electric drive system of an electric drive system for a vehicle including a first pair of wheels and a second pair of wheels, wherein the electric drive system comprises:
a main electric drive system configured to drive the first pair of wheels via a first train of torque transmitters; and
the auxiliary electric drive system configured to transmit drive power from an electric motor to the second pair of wheels via an interruptive second train of torque transmitters including:
a differential;
a layshaft disposed between the electric motor and the differential;
a first layshaft gear configured to rotate freely relative to the layshaft via a needle bearing, and wherein the first layshaft gear is further configured to connect to a rotor of the electric motor to transfer a torque from the electric motor to the layshaft;
a second layshaft gear and a differential gear connected to each other to transfer the torque between the layshaft and the differential;
a flange is provided inside of the first layshaft gear so that a hollow space is formed between the first layshaft gear and the flange, wherein the flange is fixedly attached to the layshaft so that the flange in combination with the first layshaft gear is capable of transferring the torque from the electric motor to the layshaft; and
a one-way clutch (OWC) provided to fit the hollow space,
wherein the method comprising:
turning the electric motor on when an additional propulsive energy is required above a primary propulsive energy level provided by the main electric drive system;
connecting the first layshaft gear and the flange as a block by engaging the OWC when the electric motor is on and an angular speed of the first layshaft gear is equal to or faster than an angular speed of the flange, thereby allowing the torque to be transferred from the electric motor to the layshaft and then from the layshaft to the differential; and
disconnecting the first layshaft gear from the flange by disengaging the OWC when the electric motor is off and the angular speed of the first layshaft gear is lower than the angular speed of the flange, thereby allowing the layshaft to rotate freely relative to the first layshaft gear to prevent rotation of the first layshaft gear and of the rotor of the electric motor.
